(19) United States
(12) Patent Application Publication
(10) Pub. No.: US 2003/0120530 A1
(43) Pub. Date: Jun. 26, 2003

(54) Method and system for performing a context-dependent service

(76) Inventors: Fabio Casati, Palo Alto, CA (US); Ming-Chien Shan, Saratoga, CA (US)

Correspondence Address: HEWLETT-PACKARD COMPANY, Intellectual Property Administration, P.O. Box 272400, Fort Collins, CO, 80527-2400, US

(21) Appl. No.: 10/032,363

(22) Filed: Dec. 21, 2001

(51) Int. Cl. G06F 17/60

(52) U.S. Cl. 705/8

(57) ABSTRACT

A method and system for performing a context-dependent service is disclosed. In one method embodiment, the present invention accesses a composite service. The present invention further accesses context information. The present invention automatically incorporates the context information with the composite service.

### TECHNICAL FIELD

The present claimed invention relates to the field of workflow management. More particularly, the present claimed invention relates to a context-dependent service.

### BACKGROUND ART

Today, organizations use the internet not only as an efficient and cost-effective way to sell products and deliver information, but also as a platform for providing services to businesses and individual users. In fact, many companies are rushing to provide all sorts of services on the web. These services range from the more “traditional” types, such as on-line travel reservations and directory services, to real-time traffic reports and even outsourcing of entire business functions of an organization, such as the information technology (IT) or human resources departments.

Typically, the services which are made available electronically to users or applications are called e-services. In general, the implementation of an e-service is rather complex. In fact, the business process used to complete a service may need to combine several applications or e-services. This combination of several other applications or e-services is known as a composite service. In addition, the applications or e-services may be provided by different companies. For instance, to complete a car repair service, it may be necessary for the business process to access the schedules of several repair shops and also to order the required parts from a vendor or supplier.

Unlike “traditional” business processes, which are mostly executed in a predictable and repetitive way, composite services delivered through the internet have to cope with a highly dynamic environment. That is, an environment wherein new services become available on a daily basis and the number of service providers is constantly changing. In addition, the availability of service providers from many different countries increase competition and force companies to provide customized services to the individual customer. These two characteristics of the e-service environment impose demanding requirements on any system that aims at supporting the development and delivery of composite services.

Usually composite e-services are implemented on top of an infrastructure that supports business process development, deployment, and execution. This infrastructure is typically composed of an automation layer and an integration layer. The automation layer enables the high-level specification, enactment, and management of the business processes. Typically products offering these functionalities are called Workflow Management System (WfMS) (in this document, the terms “composite service,” “workflow,” and “process” are used as synonyms). The integration layer provides a uniform interface and access method to heterogeneous applications and e-services. Typically, products offering integration functionalities are called message (or event) brokers. As previously stated, these applications or e-services may be provided by a number of different companies.

A conventional composite e-service execution system is shown in FIG. 1. Specifically, FIG. 1 illustrates the process, utilized in the conventional art, for a composite e-service execution system 100. Specifically, composite e-service execution system 100 includes workflow engine 102 which further includes node definitions repository 106, process definitions repository 108, and process execution data 110.

In general, node repository 106 is a storage area which maintains different types of nodes. It may include service, decision, and event nodes. Service nodes represent the invocation of a basic or composite service, or of an application. Decision nodes specify the alternatives and rules controlling the execution flow, and event nodes enable processes to send and receive several types of events.

Process definitions 108 are specified, in one embodiment, as a flowchart type of structure as a representation of a physical process. As a result, process definitions 108 outlines the steps required by the composite service. Process execution data 110 contains run-time execution data for each composite service, required to work through the flowchart and ultimately the utilized nodes.

An example of a composite service execution is described herein. Specifically, an initial request is placed upon workflow engine 102. Workflow engine 102 then queries process definitions 108 to retrieve a process definition. Process definitions 108 then establish a flowchart of the actions required to complete the request. Workflow engine 102 then executes the flowchart by activating the nodes and by accessing process execution data 110 to evaluate decision nodes.

Currently, WFMS do not provide any support for executing a process tailored to a specific user and to the context in which the user is. In fact, in order to more efficiently provide the additional information not found in process execution data 110, e-services providers have offered some very limited personalization capabilities. Often, these capabilities are based on the user's profile which is communicated by the users themselves or inferred by past service executions. However, the recent mobile technological advancements result in people being more connected than ever and therefore demand the e-services in (almost) any place and at (almost) any time. Therefore, users would like to have services that are specifically tailored to the context in which they reside. However, they do not want to enter the context information manually. In fact, for mobile users it is particularly impractical and inconvenient to navigate menus and enter lots of data to specify the exact service needed, especially if they access the service via devices with small screens or keypads.

A further inconvenience is that both WfMSs and message brokers were designed based on the notion of a “static” world. Specifically, the challenges and opportunities related to user mobility and increased connectivity was not taken into account.

Therefore, there exists a need in the prior art for a method and system for performing a context-dependent service (c-service). A further need exists for a method and system for performing a c-service which is tailored not only to a specific user and his/her location, but also to the particulars of the user at the time the service is requested. Yet another need exists for a method and system for performing a c-service which anticipates the user's needs to the possible extent, and deliver services where and when appropriate. A further need exists for a method and system for performing a c-service which provides automation and integration functionality.

### DISCLOSURE OF THE INVENTION

The present invention provides, in various embodiments, a method and system for performing a c-service. The present invention further provides a method and system for performing a c-service which is tailored not only to a specific user and his/her location, but also to the particulars of the user at the time the service is requested. The present invention also provides a method and system for performing a c-service which anticipates the user's needs to the possible extent, and deliver services where and when appropriate. The present invention further provides a method and system for performing a c-service which provides automation and integration functionality.

Specifically, in one method embodiment, the present invention accesses a composite service. The present invention further incorporates context information into the composite service. Specifically, the context information is automatically integrated into the composite service.

These and other advantages of the present invention will no doubt become obvious to those of ordinary skill in the art after having read the following detailed description of the preferred embodiments which are illustrated in the various drawing figures.

### BRIEF DESCRIPTION OF THE DRAWINGS

The accompanying drawings, which are incorporated in and form a part of this specification, illustrate embodiments of the invention and, together with the description, serve to explain the principles of the invention:

CONVENTIONAL ART FIG. 1 is a block diagram depicting a “traditional” composite service.

FIG. 2 is a block diagram depicting a context-dependent composite service in accordance with one embodiment of the present invention.

FIG. 3 is a flow chart of steps in a method to define a c-service in accordance with one embodiment of the present invention.

FIG. 4 is a flow chart of steps in an example of a c-service in accordance with one embodiment of the present invention.

The drawings referred to in this description should be understood as not being drawn to scale except if specifically noted.

### BEST MODES FOR CARRYING OUT THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail as not to unnecessarily obscure aspects of the present invention.

In one embodiment, the processes described herein, for example, in flowcharts 300 and 400, are comprised of computer readable and computer executable instructions which reside in data storage features of a generic computer system. The generic computer system includes, for example, nonvolatile and volatile memory, a bus, architecture, and a processor. Further, the computer-readable and computer-executable instructions are used to control, or operate in conjunction with, the processor.

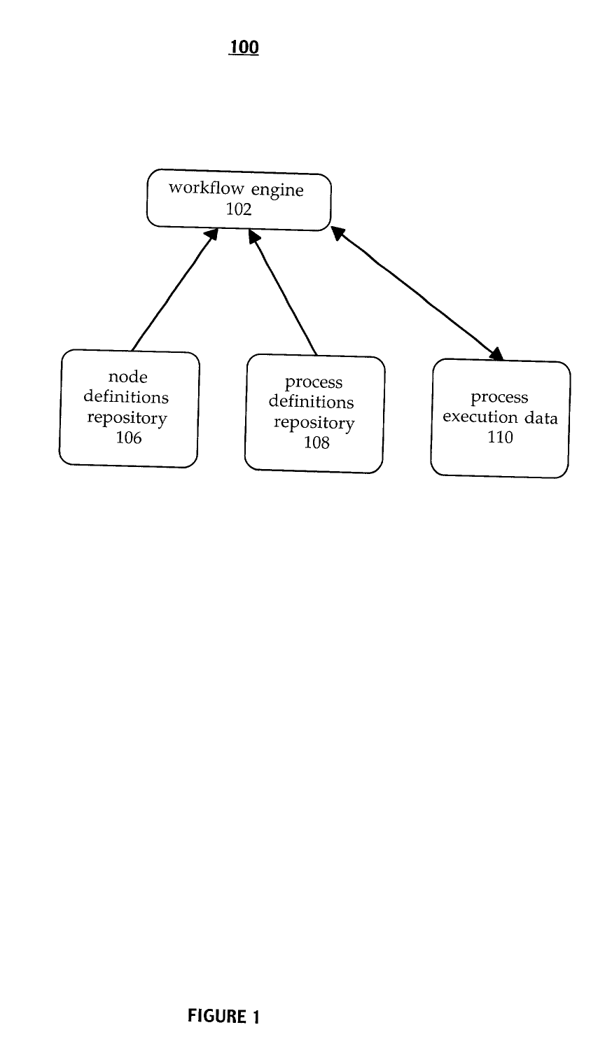

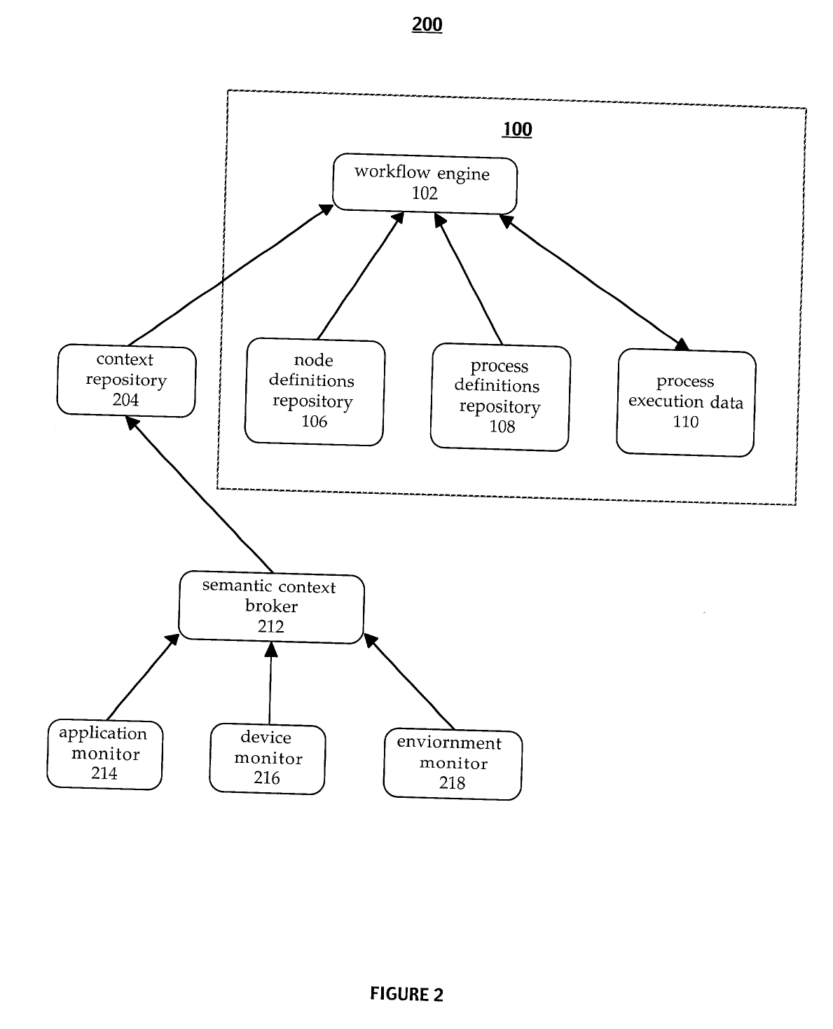

As an overview, the present c-service system 200 depicted in FIG. 2, employs workflow engine 102 which uniquely combines context repository 204, node repository 106, process definitions 108, and process execution data 110. Specifically, system 200 incorporates context repository 204 into a traditional workflow format. However, system 200 is unlike the approach taken by the prior art. In the prior art, no support for obtaining and maintaining context information was provided. In the present invention, system 200 automatically integrates the context information found in context repository 204. Specifically, context repository 204 utilizes semantic context broker 212 to maintain up-to-date context information about users. Thus, it is appreciated that system 200 provides a service which automatically integrates context information into a workflow engine. In so doing, system 200 anticipates a users need, and delivers services when appropriate without engaging the user in unnecessary data entry.

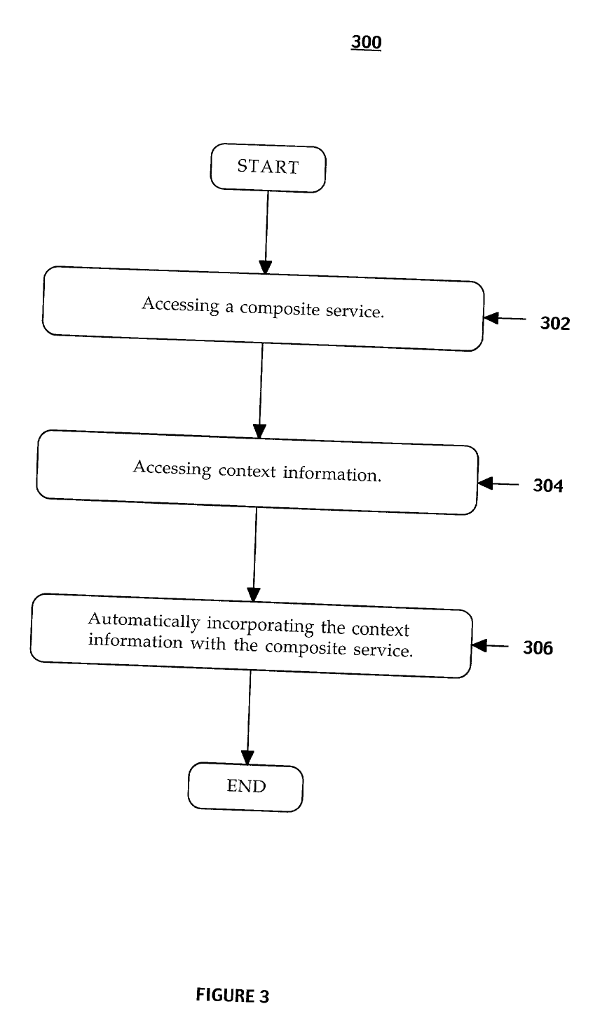

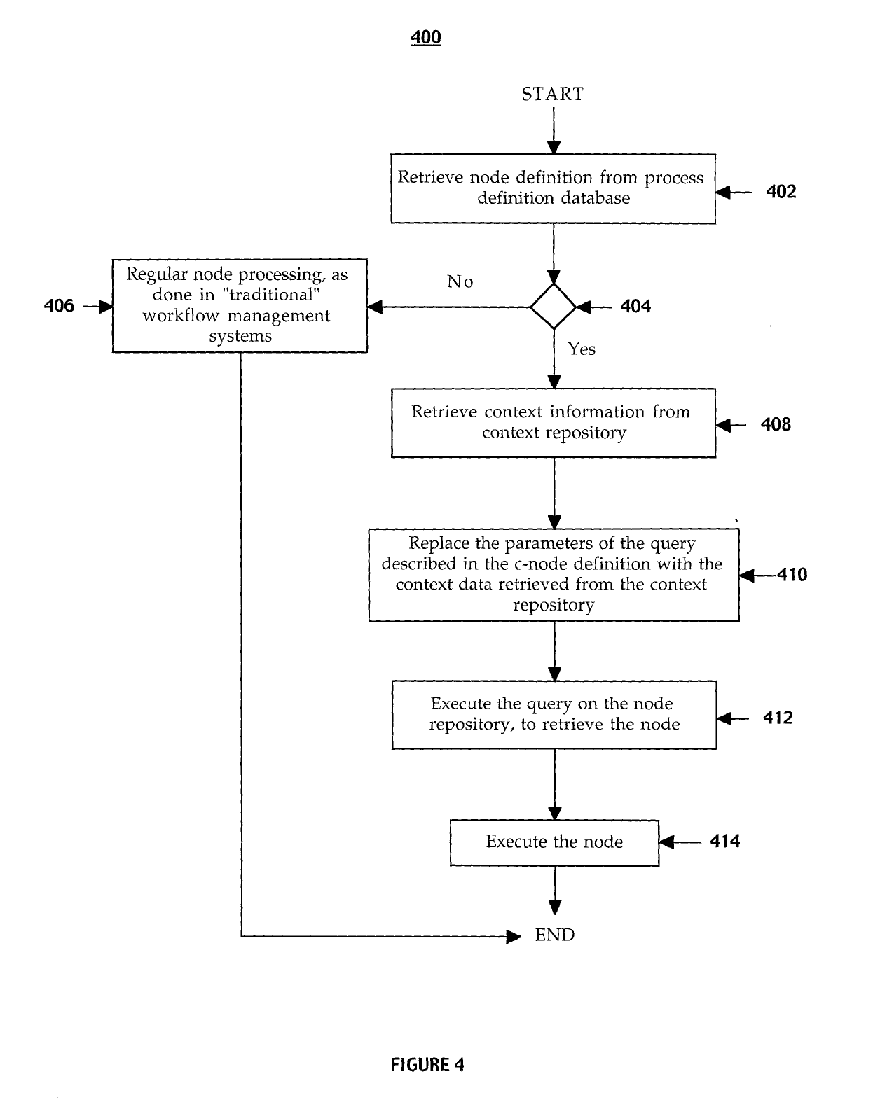

One embodiment of the present c-service execution system 200 is disclosed in FIG. 2. For purposes of clarity, the following discussion will refer to the present integrated action plan forming system of FIG. 2 in conjunction with the flow charts of FIGS. 3 and 4. With reference to step 302 of FIG. 3, the present c-service execution system 200 accesses a composite service definition stored in process definitions repository 108. In one embodiment, c-service execution system 200 is a workflow. In either case, a workflow definition 102 is a computerized representation which can utilize sequential steps and/or parallel steps to support the execution of a business process. In the present embodiment, workflow engine 102 is comprised of context repository 204, node definitions repository 106, process definitions repository 108, and process execution data 110. It is appreciated that the present invention will focus specifically on context repository 204, as node repository 106, process definitions 108, and process execution data 110 are the “traditional” methods utilized by current composite service technology as described in the background art and obviously familiar to anyone skilled in the art.

With reference still to step 302 of FIG. 3 and FIG. 2, a composite service is a service which is defined or composed of more than one service. It is also appreciated that a composite service is an electronically available e-service. An example of a simple e-service would be a service that sells a plane ticket in order to travel from point A to point B. It can be considered a simple e-service since the actual service is performed without invoking other e-services. An example of composite service is instead a travel reservation service, that is composed of a hotel reservation service, a flight reservation service, and a rental car service.

With reference now to step 304 of FIG. 3 and to FIG. 2, the present invention accesses context information. In one embodiment, context information is maintained in context repository 204. In the conventional art, initial efforts in developing context information for mobile users focused on delivering information based on the users' location. Typically, these “traditional” services received the users' location as input, used the location as search criteria in a (possibly spatial) database, and returned the information to the user. In any case, no specific support for retrieving and maintaining context information is provided in prior-art workflow management systems.

However, the present c-services go well beyond this basic functionality. In fact, c-services extend beyond that of location-dependent (sometimes called location-based) services, by progressively adding semantics to the concept of location. In fact, location-based services only customize their offering based on the geographical (latitude, longitude, and height) or geo-political (e.g., city, state, and country) position. However, many services require higher-level information about user location in order to be effective. For instance, teleconferencing services may be interested in knowing in which meeting room the user is located. Other examples of semantically extended notions of location include the following:

“Seaside” or “Mountain”

“at work” or “at home”, and more in detail:

In the “cubicle”, “meeting room XYZ”, or “cafeteria”

In the “living room”, “kitchen”, “bathroom”, . . .

On a “boat”, “car”, “train”, . . .

Weather related:

In a “warm” or “cold” place

In the “rain”, “storm”, or “sunshine”

In a “humid” or “dry” place

Human environment

Based on the spoken language

Based on the kind of activities typical of a location (e.g., skiing, swimming, sightseeing, camel riding . . . )

In addition, context information is also interested in the future location of users. For instance, context information needs to know if a user is flying to a certain city or country, coming back home, entering the living room, or will soon leave the house by car to go to work. The notion of location is even broadened to include the current occupation of the user (e.g., in a meeting, on the phone, resting, on holiday, watering the plants). Context information is even interested in specific user information ranging from bank account balances to health conditions.

The above list clearly shows that there are many different kinds of context information related to a user. Accordingly, any or all of this information may be required at different levels of granularity and precision. It is also appreciated, that some of it may be automatically detected, while other information may be predicted by sophisticated applications based on the analysis of past behaviors of the same or “similar” users.

To correctly apply the myriad of context information, and execute the particular c-services, a semantic context broker 212 is utilized. Specifically, a difference in context information may result in a different execution of a particular c-service. For example, a telephone line activation service requires different steps in different regions or countries. In general, the actual number of different implementations that are required to best deliver the c-service is unlimited. Therefore, semantic context broker 212 utilizes application monitor 214, device monitor 216, and environment monitor 218 to obtain the necessary context and context change information. Although three specific types of context varieties are used, the present invention is well suited to either more or less context establishing devices as input for semantic context broker 212. The use of the previously mentioned three inputs for semantic context broker 212, is illustrated merely as one embodiment, not as a limitation.

With reference still to step 304 of FIG. 3 and FIG. 2, application monitor 214 comprises software applications that monitor databases on other software applications. Device monitor 216 comprises components that monitor items which range from computer apparatus to vehicles. Environment monitor 218 comprises components that monitor temperature, humidity, and other environmental characteristics. Most of the previously mentioned lists deal with both present and future locations and occupations.

With reference now to step 306 of FIG. 3 and to FIG. 4, the present invention automatically incorporates the context information with the composite service. The flowchart of FIG. 4 shows the process used by one embodiment of the present invention to apply context information to system 200.

With reference now to step 402 of FIG. 4, workflow engine 102 is tasked with a request to execute a composite service. The request may come from a user, or the request may be generated by system 200 in anticipation of a users needs. In either case, workflow engine 102 then retrieves a process definition from process definitions database 108. As previously described, process definitions 108 lays out a flowchart of the steps required to fulfill the request.

With reference next to step 404 of FIG. 4, workflow engine 102 makes a decision about the need for context information with regard to the present request. If no context information is required then workflow engine 102 continues to step 406, wherein regular node processing, done in “traditional” workflow management systems, takes place. An example of a “traditional” node which could possibly be done without context may be reserving a rental car or booking passage on a train. Although this is stated as a node which could be performed without context, it could also easily be done with context.

With reference still to step 404 of FIG. 4, if there is a need for context information then a context node (c-node) is utilized (i.e., the process definition will include a c-node instead of e-service node). In one embodiment, a c-node may further be a meta-node. Specifically, a meta-node is a node which does not specify the service to be invoked, but infact allows the selection of nodes during run time, e.g. a selection of a node based on context. As a result of the selection of a c-node, workflow engine 102 proceeds to step 408, wherein context information is retrieved from context repository 204. An example of a c-node would be a request to arrange a trip. In such a request, the c-node would decide if the user prefers a car or train. If the car was preferred, then the composite service would utilize a rental car node. Again, semantic context broker 212 would be queried to decide the kind of rental car. Specific context preferences may include the amount of room required in the car, rental price, weather, rental dealer, location, etc. In this second case, context information is not used to select a node, but rather to select the best service provider (e.g., the best rental car agency) that can deliver the service to the customer.

As stated above, context repository 204 utilizes semantic context broker 212 to receive context information. Accordingly, semantic context broker 212 utilizes application monitor 214, device monitor 216, and environment monitor 218 to evaluate and supply all necessary context information. Of particular significance, the context information is maintained in the context repository. Furthermore, the context information is related to the specific user.

With reference now to step 410 of FIG. 4, workflow engine 102 then replaces the parameters of the query described in the c-node process definitions 108 with the context data retrieved from context repository 204. Specifically, the context data retrieved from context repository 204 is used in place of process execution data 110. In another embodiment, the context data retrieved from context repository 204 is used in conjunction with process execution data 110.

With reference next to step 412 of FIG. 4, a query is then executed on node repository 106 to retrieve a node. In general, as previously shown in the conventional art, once a specific node is found, workflow engine 102 then executes the node as shown in step 414 of FIG. 4. As a result, the user does not need to interact with workflow engine 102 in order for a node to complete its process. Therefore, the user is able to remain completely separated from the process while the context information is automatically incorporated with workflow engine 102.

Thus, the present invention provides, in various embodiments, a method and system for performing a context-dependent service. The present invention further provides a method and system for performing a context-dependent service which is tailored not only to a specific user and his/her location, but also to the particulars of the user at the time the service is requested. The present invention also provides a method and system for performing a context-dependent service which anticipates the user's needs to the possible extent, and deliver services where and when appropriate. The present invention further provides a method and system for performing a context-dependent service which provides automation and integration functionality.

The foregoing descriptions of specific embodiments of the present invention have been presented for purposes of illustration and description. They are not intended to be exhaustive or to limit the invention to the precise forms disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

What is claimed is:

1. A method for performing a context-dependent service comprising:
executing a composite service;
accessing context information; and
automatically incorporating said context information with said composite service.

2. The method as recited in claim 1, wherein said composite service comprises:
a node definitions repository;
process definitions repository; and
process execution data.

3. The method as recited in claim 2, wherein said composite service is an electronically available e-service.

4. The method as recited in claim 1, wherein said context information is related to a user.

5. The method as recited in claim 1, wherein said context information is maintained in a context repository.

6. The method as recited in claim 5, wherein said context repository is maintained and updated by:
a semantic context broker;
an application monitor;
a device monitor; and
an environment monitor.

7. The method as recited in claim 5, wherein said context information is automatically incorporated with said composite service without requiring action by said user.

8. The method as recited in claim 1, wherein said context dependent service includes a c-node.

9. The method as recited in claim 8, wherein said c-node is executed by selecting a process execution time node to be invoked, based on context information.

10. A computer system comprising:
a bus;
a memory unit coupled to said bus; and
a processor coupled to said bus, said processor for executing a method for performing a context-dependent service comprising:
executing a composite service;
accessing context information; and
automatically incorporating said context information with said composite service.

11. The computer system of claim 10, wherein said composite service comprises:
a node definitions repository;
process definitions repository; and
process execution data.

12. The computer system of claim 11, wherein said composite service is an electronically available e-service.

13. The computer system of claim 10, wherein said context information is related to a user.

14. The computer system of claim 10, wherein said context information is maintained in a context repository.

15. The computer system of claim 14, wherein said context repository is maintained and updated by:
a semantic context broker;
an application monitor;
a device monitor; and
an environment monitor.

16. The computer system of claim 14, wherein said context information is automatically incorporated with said composite service without requiring action by said user.

17. A computer-usable medium having computer-readable program code embodied therein for causing a computer system to perform a method for performing a context-dependent service comprising:
executing a composite service;
accessing context information; and
automatically incorporating said context information with said composite service.

18. The computer-usable medium of claim 17, wherein said composite service comprises:
a node definitions repository;
process definitions repository; and
process execution data.

19. The computer-usable medium of claim 18, wherein said composite service is an electronically available e-service.

20. The computer-usable medium of claim 17, wherein said context information is related to a user.

21. The computer-usable medium of claim 17, wherein said context information is maintained in a context repository.

22. The computer-usable medium of claim 21, wherein said context repository maintained and updated by:
a semantic context broker;
an application monitor;
a device monitor; and
an environment monitor.

23. The computer-usable medium of claim 21, wherein said context information is automatically incorporated with said composite service without requiring action by said user.
